(19) United States
(12) Patent Application Publication
(10) Pub. No.: US 2013/0008180 A1
(43) Pub. Date: Jan. 10, 2013

(54) METHOD AND APPARATUS FOR DISTRIBUTED CLEFT AND LIBERATED TILE DETECTION ACHIEVING FULL COVERAGE OF THE TURBINE COMBUSTION CHAMBER

(76) Inventors: Evangelos V. Diatzikis, Chuluota, FL (US); Hans-Gerd Brummel, Berlin (DE); Michael Twerdochlib, Oviedo, FL (US)

(21) Appl. No.: 13/177,717

(22) Filed: Jul. 7, 2011

(51) Int. Cl. F02C 7/00; G01K 11/32; G01N 21/88

(52) U.S. Cl. 60/803; 356/73.1; 374/161; 374/E11.015

(57) ABSTRACT

A component sensing system for monitoring the condition of ceramic tiles in a combustion chamber of a gas turbine engine. The sensing system includes an optical fiber that is mounted to the component being monitored, for example, the ceramic tiles in the gas turbine combustion chamber. The optical fiber can be formed in any suitable orientation or configuration, such as a meandering or serpentine orientation. The fiber is optically coupled to a Brillouin signal analyzer that provides an optical pulse to the sensing section of the fiber and detects Brillouin backscattering from the fiber as the pulse travels along the fiber. The frequency of the Brillouin backscattering signal is monitored relative to the distance along the sensing section of the fiber. A rise in temperature at a location of the fiber shows up in the analyzer as an increase in frequency of the backscattered signal.

### BACKGROUND OF THE INVENTION

1. Field of the Invention

This invention relates generally to a sensor system for detecting defects in a component using Brillouin backscattering and, more particularly, to a sensor system for detecting defects in a component, where the system includes an optical fiber coupled to the component and a Brillouin signal analyzer coupled to the optical fiber that detects changes in the frequency of a Brillouin backscattered signal at identifiable locations along the fiber in response to changes of a measurand, such as temperature.

2. Discussion of the Related Art

All optical fibers generate a backscatter signal in response to an optical beam propagating through the fiber and interacting with the fiber glass, or other fiber material, referred to as Brillouin backscattering and well known to those skilled in the art. The frequency of the backscatter signal is related to the frequency of the optical beam, the material of the fiber and a particular measurand operating within the optical fiber, where a shift in the frequency of the backscatter signal is directly related to changes in the measurand. The measurand can be temperature, pressure, interfaces, etc. that induce a change in the glass matrix of the optical fiber.

Brillouin backscattering analysis has been employed in the communications industry to determine the location of slices, breaks, interfaces, etc. in optical fibers. When the optical beam propagating through the fiber interacts with these types of transitions, the frequency of the backscattered signal changes, which can be observed in a Brillouin signal analyzer that plots Brillouin backscattering frequency relative to distance along the fiber. In addition, sensors and sensor systems have been developed using Brillouin Optical Time Domain Reflectometers (BOTDR) to interrogate the optical fiber along its length as a distributed optical sensor. These systems have proven to be successful in telecommunications applications, but are limited as sensors. Particularly, in the field of high temperature monitoring, there are no BOTDRs that can deliver the necessary spatial resolution and temperature dynamic range required to be practical.

A gas turbine engine typically includes a compressor section, a combustion section and a turbine section, where operation of the engine rotates an output shaft to provide rotational energy in a manner that is well understood by those skilled in the art. Gas turbine engines have various known applications as an energy source, such as electric generators in a power generating plant, aircraft engines, ship engines, etc. The compressor section and the turbine section both include a plurality of rotatable blades positioned relative to stationary vanes. The combustion section may include a plurality of combustors circumferentially positioned around the turbine engine. Air is drawn into the compressor section where it is compressed and driven towards the combustion section. The combustion section mixes the air with a fuel where it is ignited to generate a working gas typically having a temperature above 1300° C. The working gas expands through the turbine section and causes the turbine blades to rotate, which in turn causes the output shaft to rotate, thereby providing mechanical work. A more detailed discussion of a gas turbine engine of this type can be found in U.S. Pat. No. 7,582,359, titled Apparatus and Method of Monitoring Operating Parameters of a Gas Turbine, assigned to the assignee of this application and herein incorporate by reference.

In one gas turbine engine design, the combustion section includes an annular combustion chamber that is provided around a complete circumference of the engine. Burners are disposed around the combustion section that inject fuel into the chamber where it is ignited. Because the temperatures are very high in the combustion chamber, it is known to mount ceramic tiles to the base metal of the chamber that are able to withstand and limit the dissipation of heat to protect various components in the turbine. However, because of the harsh combustion environment, these tiles sometimes become damaged, and form a cleft, or become dislodged from the base metal, which could cause as secondary damage various machine failures, catastrophic and otherwise. The combustion chamber of a gas turbine engine is periodically visually inspected during normal maintenance of the engine, as well as after the occurrence of combustion dynamic events above a certain acceleration threshold. However, it would be desirable to be able to continuously monitor the condition of the tiles during operation of the turbine.

### SUMMARY OF THE INVENTION

In accordance with the teachings of the present invention, a component sensing system is disclosed that has one application for monitoring the condition of ceramic tiles in a combustion chamber of a gas turbine engine. The sensing system includes an optical fiber that is mounted to the component being monitored, for example, the ceramic tiles in the gas turbine combustion chamber. The optical fiber can be formed in any suitable orientation or configuration, such as a meandering or serpentine orientation. The fiber is optically coupled to a Brillouin signal analyzer that provides an optical pulse to the sensing section of the fiber and detects Brillouin backscattering from the fiber as the pulse travels along the fiber. The frequency of the Brillouin backscattering signal is monitored relative to the distance along the sensing section of the fiber. A rise in temperature at a location of the fiber as a result of a particular tile being damaged or removed shows up in the analyzer as an increase in frequency of the backscattered signal.

Additional features of the present invention will become apparent from the following description and appended claims, taken in conjunction with the accompanying drawings.

### BRIEF DESCRIPTION OF THE DRAWINGS

FIG. 1 is a cut-away, perspective view of a portion of a combustion section of a gas turbine engine;

FIG. 2 is a plan view of a distributed temperature anomaly detector system operable to detect damage to ceramic tiles in the combustion section of the gas turbine engine shown in FIG. 1; and

FIG. 3 is a cut-away, perspective view showing various layers in an optical fiber.

### DETAILED DESCRIPTION OF THE EMBODIMENTS

The following discussion of the embodiments of the invention directed to a sensing system that monitors Brillouin backscattering is merely exemplary in nature, and is in no way intended to limit the invention or its applications or uses. Particularly, the discussion below is directed to using the sensing system for detecting damage to tiles in a combustion chamber of a gas turbine engine. However, as will be appreciated by those skilled in the art, the sensing system of the invention will have other applications and other uses.

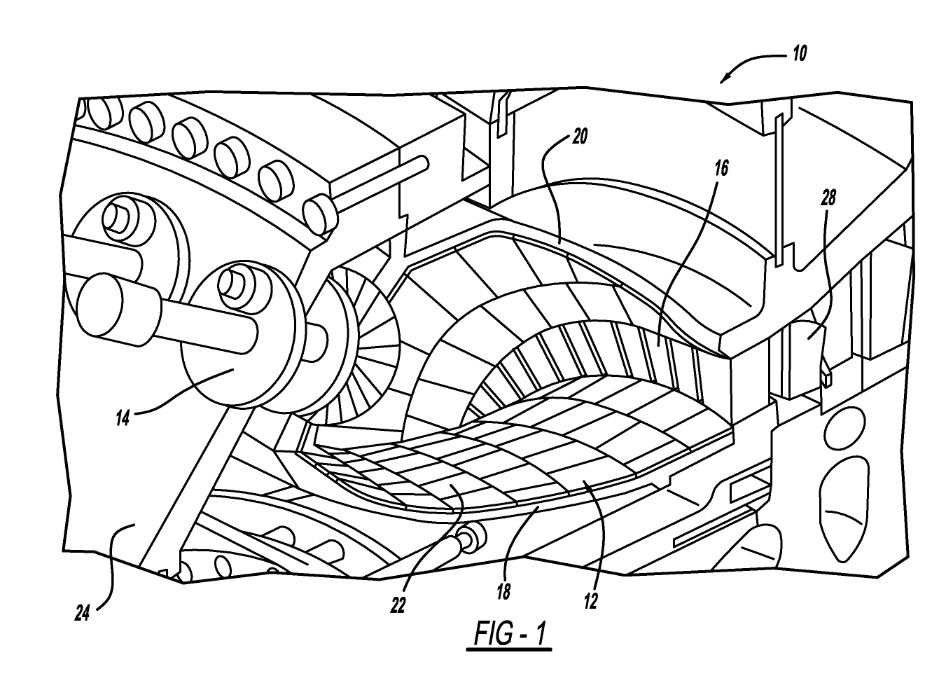

FIG. 1 is a cut-away, perspective view of a combustion section 10 of a gas turbine engine of the type briefly discussed above. The combustion section 10 includes an annular combustion chamber 12 that receives a flow of air and a suitable fuel injected into the chamber 12 by a series of gas injectors 14 circumferentially mounted to an exterior wall 24 of the combustion section 10. A heated gas generated by combustion of the fuel in the chamber 12 is drawn to the turbine section (not shown) of the engine between vanes 16 in the chamber 12 by rotating blades 28 and is used to rotate a shaft (not shown) to perform work. The combustion chamber 12 is annular and has a cylindrical center member 18 circumferentially surrounded by an outer wall 20 defining the chamber 12 therebetween. A series or array of ceramic tiles 22 are mounted to the member 18 and the outer wall 20 in a manner that is well understood by those skilled in the art. The tiles 22 are made of a high temperature ceramic material that limits the dissipation of heat to the outer casing and rotor sided metal structures of the combustion chamber 12, as is well understood by those skilled in the art to protect the base metal of the combustion chamber 12. The tiles 22 can have any suitable thickness and any suitable dimension, such as 3 by 4 inches, for the purposes discussed herein. As discussed above, if the tiles 22 form a cleft, or become dislodged or otherwise damaged, serious engine failure could occur. The most severe resulting problem is the liberation of an entire tile 22 or a part of the tile 22 from the chamber 12. This ceramic tile 22 can block part of the gas flow area directly upstream of the first gas turbine vane, resulting in a dead flow area downstream with higher static pressure than the surrounding flow path. Thus, during one revolution, each turbine blade faces high and low pressure areas, which could result in blade failures and severe turbine damage.

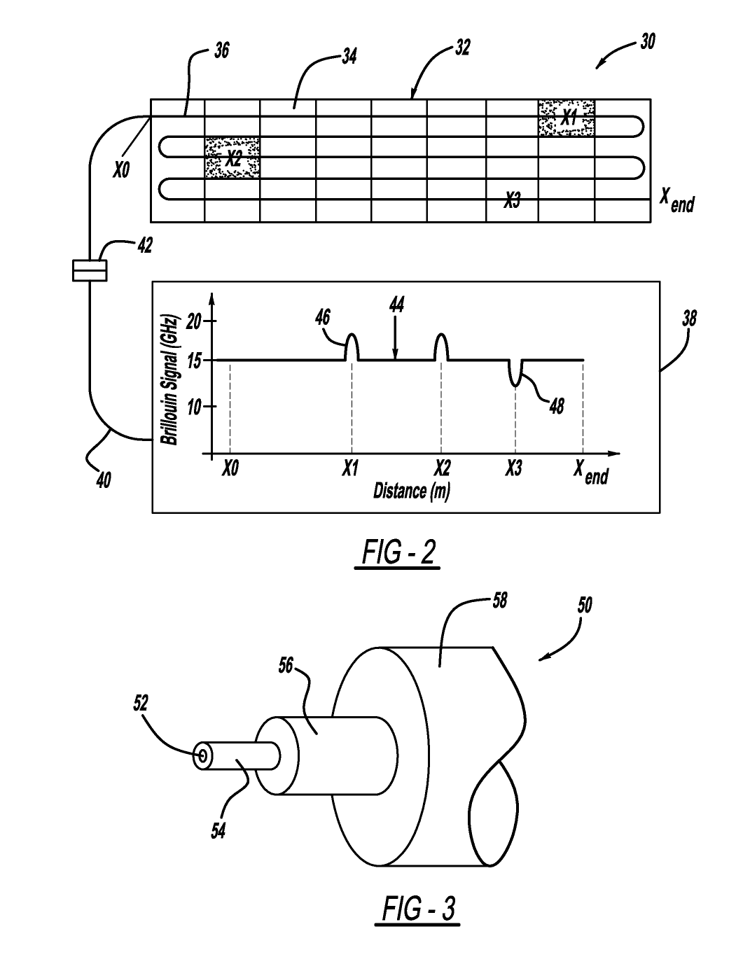

FIG. 2 is a plan view of a distributed temperature anomaly detector (DTAD) system 30 suitable to detect cleft, or other damage, to the tiles 22 during operation of the gas turbine engine. The DTAD system 30 includes a high temperature DTAD optical fiber 36 having a sensing section that is mounted within the combustion chamber 12 between the tiles 22 and the base metal of the walls 18 and 20. The fiber 36 can be provided at this location using any suitable technique or process, such as forming grooves in a surface of the walls 18 and 20 or the back surface of the tiles 22 in which the fiber 36 can be positioned. A suitable high temperature cement could be employed to securely hold the fiber 36 in place. The tiles 22 are represented as an array 32 of tiles 34, particularly a row of rectangular tiles, as part of the system 30. The fiber 36 is shown mounted relative to a back surface of the tiles 34 in this non-limiting embodiment in a serpentine or meandering orientation so that the fiber 36 goes back and forth along the array 32 and crosses each tile 34 five times. The amount of resolution or coverage of the fiber 36 on each separate tile 34 would be application specific in that the length and orientation of the fiber 36 can be modified from system to system.

The system 30 includes a Brillouin signal analyzer 38 that generates a pulsed signal of a predetermined frequency that propagates down the fiber 36, where the signal interacts with the glass matrix, or other material, of the fiber 36 and generates a Brillouin backscattered signal as discussed above. The analyzer 38 receives the Brillouin backscattered signal, shown as trace signal 44, and displays the frequency of the signal 44 relative to the distance along the fiber 36, where the position along the fiber 36 defines a location on the tiles 34. The analyzer 38 includes an optical fiber 40 that can be optically coupled to the fiber 36 by a suitable optical connector 42. In this manner, the analyzer 38 can be detached from the fiber 36 if it is desirable to only attach the analyzer 38 to the fiber 36 during tile testing. Alternately, the analyzer 38 can be a permanent part of the gas turbine engine, where it is the optical fiber 36 itself that is coupled to the analyzer 38.

In this non-limiting embodiment, the pulsed signal provided by the analyzer 38 generates a 15 GHz backscattered heterodyne signal as the trace signal 44, where the incident/backscatter frequency shift is determined by the material of the core of the fiber 36 and the frequency of the pulsed signal. Position X0 represents the location where the sensing section of the fiber 36 is first mounted to the tiles 34 and position X_{end} represents the end of the fiber 36. In this example, temperature anomalies are shown at positions X1, X2 and X3 along the fiber 36, which have a known location relative to their position on the tiles 34. In this particular example, the tiles 34 at positions X1 and X2 have formed a cleft, been removed, or otherwise damaged, where the exposed, or at least partially exposed, fiber 36 at these locations increases in temperature than would otherwise occur during normal operation of the gas turbine engine. Particularly, in this example, temperature is the measurand that changes the frequency of the backscattered signal. These “hot spots” in the fiber 36 cause an increase in the frequency of the Brillouin trace signal 44 as indicated by anomalies 46 at locations X1 and X2 in the analyzer 38. Likewise, at position X3, debris, a coating, etc., such as a carbon residue, has been deposited at that location on the tile 34 that causes a reduction in temperature of the fiber 36, which causes a decrease in the frequency of the Brillouin backscattered signal as shown by anomaly 48 in the signal trace 44.

The optical fiber 36 can include a number of layers that are made of a number of materials suitable for the purposes discussed herein. Typically, an optical fiber includes a glass core and a glass cladding layer surrounding the core, where the index of refraction of the cladding layer is less than the index of refraction of the core so that light propagating down the core that interacts with the core/cladding interface is reflected back into the core as long as the angle of incidence of the interaction is less than a critical angle that is determined based on the indexes of refraction of the core and cladding layer. One or more outer protective layers are provided around the cladding layer to protect the core and cladding layer. Typically, the core has a very small diameter, on the order of less than 10 μm, to limit the number of propagation modes in the core.

FIG. 3 is a cut-away, perspective view of a section of an optical fiber 50 that can be used as the optical fiber 36 and including an optical core 52 and an outer cladding layer 54 of the type discussed above. In this embodiment, a first coating layer 56 is provided around the cladding layer 54 and a second coating layer 58 is provided around the first coating layer 56. The thickness of the coating layers 56 and 58 can be any thickness suitable for the applications discussed herein. For example, the second coating layer 58 may have a thickness in the 900-1200 μm. Depending on the particular application and the anticipated amount of heat, the core and cladding layer can be made of a suitable high temperature fiber material that is able to withstand temperatures on the order of 1500° C. (2732° F.). Sapphire is one known material that is able to withstand these high temperatures, and is suitable as an optical fiber material.

Further, depending on the application, the coating layers 56 and 58 can be made of a material that enhances or magnifies the heating of the fiber 50, such as a metallic material, for example, gold. In other words, to ensure that the core 52 carrying the Brillouin signal is heated quickly enough and to a significant enough degree in response to a defect in the tile 22, where it would be easily and readily detected by the analyzer 38, materials can be used to surround the core 52 that cause the heating of the optical fiber 50 to be enhanced. Additionally, for those applications where temperature may be very high and the fiber 50 may heat very quickly, the coating layers 56 and 58 may be made of a material that retards heat, such as a ceramic material.

The discussion above is specific for detecting damage to tiles within a combustion chamber of a gas turbine engine. However, as mentioned, the DTAD system will have other applications. For example, a DTAD system can be used to detect steam leaks, where a DTAD cable can be routed adjacent to critical steam pipes and vessel connections, joints and penetrations, including turbine casing joints. If a steam leak occurs, hot steam will contact a section of the DTAD fiber identifying the leak.

In another example, the DTAD system can be used for stream drain pot function verification. In this embodiment, the DTAD fiber is routed along a drain pot and associated piping. If drain pot activation is not followed by a rise in temperature downstream of the drain pot, the analyzer can detect this occurrence, which identifies the drain pot location. Also, a partially clogged and leaking drain condition can be detected.

The DTAD system can also be used for monitoring generator collector brushes. In this embodiment, the DTAD fiber is routed over a collector brush assembly. An excessively high brush current condition results in heating of the brush assembly, which can be detected by the analyzer. A low brush current condition, such as for an underperforming brush collector assembly, can be detected by comparing temperatures of all of the collector brush assemblies, where an alarm is issued based on a deviant measurement.

The DTAD system can also be used to monitor isophase bus flex links. In this embodiment, the DTAD fiber is routed along the length of the bus in contact with each flex link, where twelve flex links at one joint can be monitored. The analyzer can detect excessive temperatures at the joint where the temperatures of all of the flex links can be compared and if a deviant low link temperature is detected, an alarm can be issued that includes the location of the non-conducting link.

The DTAD system can also be used in a flue gas duct compensator. In this embodiment, the DTAD cable can be arranged directly over or in close proximity to the flue gas duct compensator in the open environment. If there is a leak, the hot flue gas heat sensing fiber and this leak is detected by the analyzer.

The DTAD system can also be used to monitor HRSG header welds leaks. In this embodiment, the DTAD fiber is routed along the HRSG header welds, and if a failure of the weld occurs, hot gas will heat the fiber.

The DTAD system can also be used as a monitor for transitions. In this embodiment, the DTAD fiber is routed along the outer surface and interfacing joint of the transition in places that damage, such as lost metal portions, have been experienced. Metal loss resulting in the increase of cooler gas results in a reduced DTAD temperature.

The foregoing discussion discloses and describes merely exemplary embodiments of the present invention. One skilled in the art will readily recognize from such discussion, and from the accompanying drawings and claims, that various changes, modifications and variations can be made therein without departing from the scope of the invention as defined in the following claims.

What is claimed is:

1. A sensor system for detecting failure of a component, said system comprising:
an optical fiber mounted relative to the component and having a predefined length corresponding to locations on the component; and
a Brillouin backscatter signal analyzer coupled to the optical fiber, said Brillouin signal analyzer providing a pulsed optical signal propagating down the fiber and analyzing a Brillouin backscattered signal from the fiber, said analyzer identifying a frequency of the Brillouin backscattered signal relative to the length of the fiber, wherein a change in a measurand at a particular location along the length of the fiber is identified as a change in frequency of the Brillouin backscattered signal at that location.

2. The system according to claim 1 wherein the optical fiber is mounted to the component in a serpentine orientation.

3. The system according to claim 1 wherein the measurand is temperature where a change in the temperature of the fiber at a particular location causes a change in the frequency of the Brillouin backscattered signal.

4. The system according to claim 1 wherein the fiber includes a fiber core and cladding layer made of a sapphire material.

5. The system according to claim 1 wherein the fiber includes a fiber core, a cladding layer and at least one outer protective layer formed around the cladding layer, said at least one outer protective layer being made of a heat enhancing material.

6. The system according to claim 5 wherein the heat enhancing material is a metallic material.

7. The system according to claim 6 wherein the metallic material is gold.

8. The system according to claim 1 wherein the fiber includes a fiber core, a cladding layer and at least one outer protective layer formed around the cladding layer, said at least one outer protective layer being made of a heat retarding material.

9. The system according to claim 1 wherein the component is a series of ceramic tiles mounted to a wall within a combustion chamber of a gas turbine engine.

10. The system according to claim 9 wherein the fiber is provided between the wall and the tiles.

11. A sensor system for detecting failure of a component, said system comprising:
an optical fiber mounted relative to the component and having a predefined length corresponding to locations on the component, said optical fiber being mounted relative to the component in a serpentine orientation; and
a Brillouin backscatter signal analyzer coupled to the optical fiber, said Brillouin signal analyzer providing a pulsed optical signal propagating down the fiber and analyzing a Brillouin backscattered signal from the fiber, said analyzer identifying a frequency of the Brillouin backscattered signal relative to the length of the fiber, wherein a change in temperature at a particular location along the length of the fiber is identified as a change in frequency of the Brillouin backscattered signal at that location.

12. The system according to claim 11 wherein the fiber includes a fiber core and cladding layer made of a sapphire material.

13. The system according to claim 11 wherein the fiber includes a fiber core, a cladding layer and at least one outer protective layer formed around the cladding layer, said at least one outer protective layer being made of a heat enhancing material.

14. The system according to claim 11 wherein the fiber includes a fiber core, a cladding layer and at least one outer protective layer formed around the cladding layer, said at least one outer protective layer being made of a heat retarding material.

15. The system according to claim 11 wherein the component is a series of ceramic tiles mounted to a wall within a combustion chamber of a gas turbine engine.

16. A gas turbine engine comprising:
a combustion section including a combustion chamber operable to receive a fuel and air, said combustion chamber including chamber walls having a plurality of ceramic tiles mounted thereto; and
a sensor system including an optical fiber provided between the ceramic tiles and the walls of the combustion chamber, said optical fiber having a predefined length corresponding to locations along the tiles, said sensor system further including a Brillouin backscatter signal analyzer coupled to the optical fiber, said Brillouin signal analyzer providing a pulsed optical signal propagating down the fiber and analyzing a Brillouin backscattered signal from the fiber, said analyzer identifying the frequency of the Brillouin backscattered signal relative to the length of the fiber, wherein a change in temperature at a particular location along the length of the fiber is identified at a change in frequency of the Brillouin backscattered signal at that location.

17. The engine according to claim 16 wherein the optical fiber is provided between the ceramic tiles and the walls of the combustion chamber in a serpentine orientation.

18. The engine according to claim 16 wherein the fiber includes a fiber core and cladding layer made of a sapphire material.

19. The engine according to claim 16 wherein the fiber includes a fiber core, a cladding layer and at least one outer protective layer formed around the cladding layer, said at least one outer protective layer being made of a heat enhancing material.

20. The engine according to claim 16 wherein the fiber includes a fiber core, a cladding layer and at least one outer protective layer formed around the cladding layer, said at least one outer protective layer being made of a heat retarding material.
